(19) United States
(12) Patent Application Publication
(10) Pub. No.: US 2019/0056800 A1
(43) Pub. Date: Feb. 21, 2019

(54) METHOD AND SYSTEM FOR MANIPULATING OBJECTS IN 3D VIRTUAL SPACE

(71) Applicant: TinMoon Studios, LLC, New York, NY (US)

(72) Inventors: James David Gonsalves, Brooklyn, NY (US); Andrew David Yount, New York, NY (US)

(73) Assignee: Tin Moon Studios LLC, New York, NY (US)

(21) Appl. No.: 16/054,838

(22) Filed: Aug. 3, 2018

Related U.S. Application Data
(60) Provisional application No. 62/545,515, filed on Aug. 15, 2017.

(51) Int. Cl. G06F 3/0346; G06T 19/00; G06F 3/01

(52) U.S. Cl. CPC G06F 3/0346; G06T 2210/21; G06F 3/011; G06T 19/006

(57) ABSTRACT

A computer-implemented method including defining a simulated object as being attached to an anchor point of a simulated motion control user interface device representative of a physical motion control user interface device, moving the simulated object in a first direction with the simulated motion control user interface device in response to a change in an orientation of the physical motion control user interface device, and moving the simulated object in a second direction in response to a command input using a command interface of the physical motion control user interface device.

### CROSS-REFERENCE TO RELATED APPLICATION AND CLAIM OF PRIORITY

This application claims priority to U.S. Provisional Application No. 62/545,515, filed Aug. 15, 2017, entitled “METHOD AND SYSTEM FOR MANIPULATING OBJECTS IN 3D VIRTUAL SPACE,” which is hereby incorporated herein by reference in its entirety.

### BACKGROUND

The present disclosure relates to manipulating simulated objects in three-dimensional virtual space.

The physical world may be simulated in three-dimensional virtual space A. The three-dimensional virtual space A may include simulated objects Ba-Bn that may be manipulated within the three-dimensional virtual space A in response to commands input using a motion control user interface device C. When the simulated objects Ba-Bn held by the motion control user interface C, the simulated objects Ba-Bn are generally directly attached to a simulated motion control user interface device C′ as a dependent object of the simulated motion control user interface device C′. Within the three-dimensional virtual space A, when attached to the simulated motion control user interface device C′, the simulated objects Ba-Bn behave as if the simulated objects Ba-Bn are extensions of the simulated motion control user interface device C′.

Real-world physical limitations may therefore make it difficult to control the simulated objects Ba-Bn in the three-dimensional virtual space A. For example, limitations on motion in the physical world, such as physical limitations on the ways a user of the physical motion control user interface device C can move, or limitations on a physical size of the room that the user occupies may prevent the user from be able to easily manipulate the simulated object Ba as desired. Furthermore, since the simulated object Ba behaves as an extension of the simulated motion control user interface device C′ when the simulated object Ba is held by the simulated motion control user interface device C′, the simulated object B does not include the physical properties that the simulated object Ba would have in the physical world, which detracts from the user's experience in the three-dimensional virtual space A. For example, as shown in FIG. 1, the simulated object Ba may violate a simulated fixed boundary D of the simulated object Bb such as a wall when attached to the simulated motion control user interface device C′. As shown in FIG. 1, the simulated object Ba extends through the boundary D when the simulated motion control user interface device C′ is near but not adjacent to or interacting with the boundary D. In contrast, in a similar interaction in the physical world, a physical object similar to the simulated object Ba would either be stopped by a physical boundary similar to the simulated boundary D or the physical object would be deflected by the physical boundary.

In another example, a first simulated object E may violate a boundary F of a second simulated object G when the first simulated object E is attached to the simulated motion control user interface device C′ and the simulated motion control user interface device C′ is near but not adjacent or interacting with the boundary F. As shown in FIG. 2, the first simulated object E is shown to extend through the boundary F of the second simulated object G and does not interact with (e.g. displace and/or deflect from) the boundary F of the second simulated object G. In contrast, in a similar interaction in the physical world, the first physical object may displace the second physical object, deflect from the second physical object, or be stopped by the second physical object.

### SUMMARY

In one embodiment, the disclosure provides a computer-implemented method including defining an articulation between a physicalized object and a motion control user interface device that does not have a physical representation, receiving a motion signal with the motion control user interface device, determining a motion path of the physicalized object based on the motion signal, determining whether movement of the physicalized object along the motion path violates at least one boundary, and responsive to determining that movement of the physicalized object along the motion path does not violate the at least one boundary, applying a force to the physicalized object to move the physicalized object along the motion path.

In another embodiment, the disclosure provides a system including a motion control user interface device configured to receive a motion signal. The motion control user interface device does not have a physical representation. The system further includes a computing device in electrical communication with the motion control user interface device. The computing device includes at least one processor and a memory. The memory includes a database including at least a first physicalized object and a second physicalized object. The memory includes program instructions executable by the at least one processor to define an articulation between the first physicalized object and the motion control user interface device, determine a motion path of the first physicalized object based on the motion signal, determine whether the second physicalized object is positioned along the motion path, and responsive to determining that the second physicalized object is not positioned along the motion path, applying a force to the first physicalized object to move the first physicalized object along the motion path.

In another embodiment, the disclosure provides a computer-implemented method including defining a first simulated object that does not have a physical representation. The first simulated object corresponds to a physical motion control user interface device. The computer-implemented method further includes defining a second simulated object that is a physicalized object having simulated physical properties. The second simulated object is defined independently from the first simulated object. The computer-implemented method further includes connecting the first physicalized object and the second physicalized object with an articulation, receiving a motion signal with the motion control user interface device, determining a motion path of the second simulated object based on the motion signal, and controlling movement of the second simulated object along the motion path based on the simulated physical properties of the second simulated object and the motion signal received by the motion control user interface device.

In another embodiment, the disclosure provides a computer-implemented method including emitting a grasping ray from a motion control user interface device, sweeping a simulated physical area for at least one simulated object with the grasping ray emitted by the motion control user interface device, determining whether the at least one simulated object is graspable, and responsive to determining that the at least one simulated object is graspable, attaching the motion control user interface device to the at least one simulated object using an articulation having a stretched position and a relaxed position. The articulation is in the stretched position when the motion control user interface device is attached to the at least one simulated object.

In another embodiment, the disclosure provides a system including a motion control user interface device configured to receive a motion signal and emit a grasping ray configured to identify at least one simulated object in a path of the grasping ray, a computing device in electrical communication with the motion control user interface device. The computing device includes at least one processor and a memory. The memory includes a database including the at least one simulated object. The memory includes program instructions executable by the at least one processor to determine whether the at least one simulated object is graspable and, responsive to determining that the at least one simulated object is graspable, attach the motion control user interface device to the at least one simulated object using an articulation having a stretched position and a relaxed position. The articulation is in the stretched position when the motion control user interface device is attached to the at least one simulated object.

In another embodiment, the disclosure provides a computer-implemented method including emitting a ray from a motion control user interface device, sweeping a simulated physical area with the ray for at least one physicalized object that includes simulated physical properties, attaching the motion control user interface device to the physicalized object using an elastic connection having a stretched position and a relaxed position. The elastic connection exerts a force when contracting from the stretched position to the relaxed position. The computer-implemented method further includes determining whether the force is strong enough to move the at least one physicalized object by analyzing the simulated physical properties.

In another embodiment, the disclosure provides a computer-implemented method including defining a simulated object as being attached to an anchor point of a simulated motion control user interface device representative of a physical motion control user interface device, moving the simulated object in a first direction with the simulated motion control user interface device in response to a change in an orientation of the physical motion control user interface device, and moving the simulated object in a second direction in response to a command input using a command interface of the physical motion control user interface device.

In another embodiment, the disclosure provides a system including a physical motion control user interface device and a computing device in electrical communication with the physical motion control user interface device. The computing device includes at least one processor and a memory. The memory includes program instructions executable by the at least one processor to define a simulated object as being attached to an anchor point of a simulated motion control user interface device representative of the physical motion control user interface device, responsive to a change in an orientation of the physical motion control user interface device, move the simulated object in a first direction, and responsive to receiving a command input with a command interface of the physical motion control user interface device, moving the simulated object in a second direction.

Other aspects of the disclosure will become apparent by consideration of the detailed description and accompanying drawings.

### BRIEF DESCRIPTION OF THE DRAWINGS

FIG. 1 illustrates a conventional three-dimensional virtual space.

FIG. 2 illustrates another conventional three-dimensional virtual space.

FIG. 3 illustrates a system for generating a three-dimensional virtual space and manipulating objects within the three-dimensional virtual space according to some embodiments.

FIG. 4 illustrates a flow diagram of a method for picking up simulated objects in the three-dimensional virtual space of FIG. 3.

FIG. 5 illustrates a simulated motion control user interface device and a simulated object in the three-dimensional virtual space of FIG. 3 according to some embodiments.

FIG. 6 illustrates the simulated motion control user interface device engaged with the simulated object in the three-dimensional virtual space of FIG. 3 according to some embodiments.

FIG. 7 illustrates the simulated motion control user interface device pulling the simulated object in the three-dimensional virtual space of FIG. 3 according to some embodiments.

FIG. 8 illustrates the simulated object engaged with the simulated motion control user interface device in the three-dimensional virtual space of FIG. 3 according to some embodiments.

FIG. 9 illustrates the simulated object engaged with the simulated motion control user interface device in the three-dimensional virtual space of FIG. 3 according to some embodiments.

FIG. 10 illustrates a flow diagram of a method for manipulating a physicalized object with respect to a physicalized boundary in a three-dimensional virtual space according to some embodiments.

FIG. 11 illustrates the physicalized object engaged with a simulated motion control user interface device contacting a physicalized boundary in a three-dimensional virtual space according to some embodiments.

FIG. 12 illustrates the physicalized object engaged with the simulated motion control user interface device deflecting off of the physicalized boundary in the three-dimensional virtual space of FIG. 11 according to some embodiments.

FIG. 13 illustrates mutual deflection of the physicalized object engaged with the simulated motion control user interface device and the physicalized boundary in the three-dimensional virtual space of FIG. 11 according to some embodiments.

FIG. 14 illustrates a simulated motion control user interface device having an anchor point according to some embodiments.

FIG. 15 illustrates a simulated motion control user interface device of FIG. 14 showing the anchor point rotated with respect to the simulated motion control user interface device according to some embodiments.

FIG. 16 illustrates the simulated motion control user interface device of FIG. 14 having the anchor point and a simulated object attached to the anchor point according to some embodiments.

FIG. 17 illustrates the simulated motion control user interface device of FIG. 14 showing the anchor point and the simulated object rotated with respect to the simulated motion control user interface device according to some embodiments.

FIG. 18 illustrates a flow diagram of a method for manipulating the simulated object engaged with the anchor point of the simulated motion control user interface device of FIG. 14 with respect to the simulated motion control user interface device according to some embodiments.

FIG. 19 illustrates a first simulated object and a simulated motion control user interface device positioned in a three-dimensional virtual space according to some embodiments.

FIG. 20 illustrates the first simulated object being pulled towards the simulated motion control user interface device in the three-dimensional virtual space of FIG. 19 according to some embodiments.

FIG. 21 illustrates the first simulated object held by the simulated motion control user interface device and a second simulated object held by a second simulated motion control user interface device in the three-dimensional virtual space of FIG. 19 according to some embodiments.

FIG. 22 illustrates the first simulated object held by the simulated motion control user interface device and the second simulated object held by the second simulated motion control user interface device in the three-dimensional virtual space of FIG. 19 according to some embodiments.

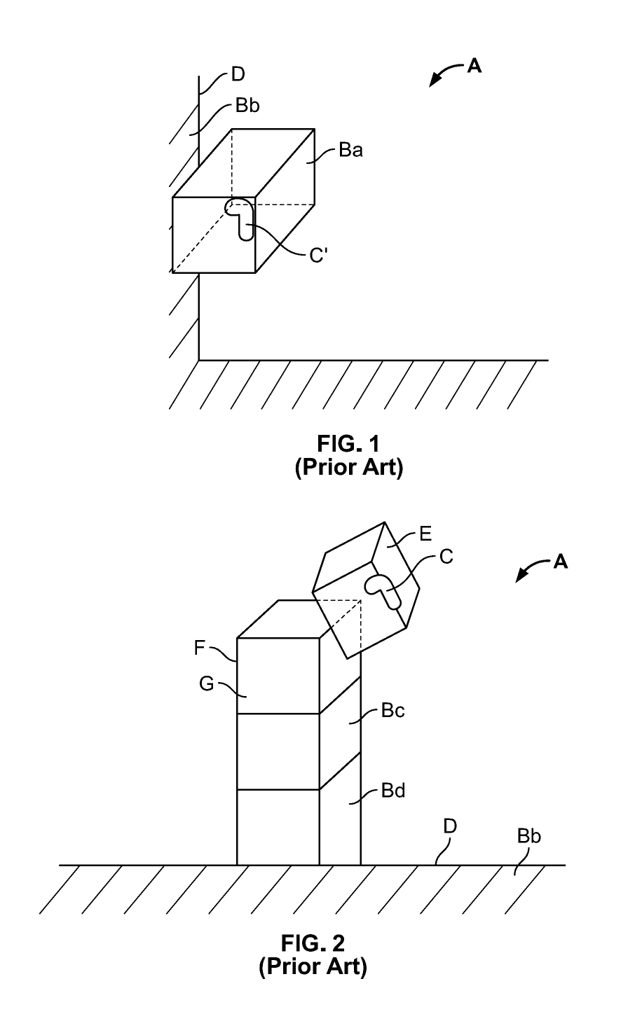

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including”, “comprising”, or “having” and variations thereof herein is meant to encompass the items listed thereafter and equivalents thereof as well as additional items. As used herein, the word “may” is used in a permissive sense (e.g. meaning having the potential to) rather than the mandatory sense (e.g. meaning must).

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared, or otherwise manipulated. It has been proven convenient at times, principally for reasons of common usage, to refer to signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, the terms “processing”, “computing”, “calculating”, “determining” or the like refer to actions or processes of a specific apparatus, such as a special purpose computer or a similar special purpose electronic computing device.

Some embodiments disclose a computer-implemented method for resolving spatial boundary conflicts of virtual objects using simulated spring constraints in 3D space. In some embodiments, the method includes defining an articulation between a physicalized object and a motion control user interface device that does not have a physical representation, receiving a motion signal with the motion control user interface device, determining a motion path of the physicalized object based on the motion signal, determining whether movement of the physicalized object along the motion path violates at least one boundary, and responsive to determining that movement of the physicalized object along the motion path does not violate the at least one boundary, applying a force to the physicalized object to move the physicalized object along the motion path.

In some embodiments, the computer-implemented method further includes, responsive to determining that movement of the physicalized object along the motion path violates the at least one boundary, applying a force to the physicalized object to move the physicalized object along the motion path to the at least one boundary.

In some embodiments, the physicalized object includes simulated physical properties and the at least one boundary includes simulated physical properties, and wherein at least the physicalized object moves relative to the at least one boundary as determined by the simulated physical properties of the physicalized object and the simulated physical properties of the at least one boundary.

In some embodiments, at least one of the physicalized object and the at least one boundary is deflected as a result of an interaction between the physicalized object and the at least one boundary or is stopped as a result of the interaction between the physicalized object and the at least one boundary.

In some embodiments, the physicalized object is simulated independently of the motion control user interface device. In some embodiments, the articulation is an elastic articulation and the force is an elastic force configured to pull the physicalized object towards the motion control user interface device. In some embodiments, the elastic articulation is infinitely extensible after the elastic force exceeds a predetermined threshold.

Some embodiments disclose a system for resolving spatial boundary conflicts of virtual objects using simulated spring constraints in 3D space. In some embodiments, the system includes a motion control user interface device configured to receive a motion signal, the motion control user interface device not having a physical representation and a computing device in electrical communication with the motion control user interface device and including at least one processor and a memory, the memory including a database including at least a first physicalized object and a second physicalized object. In some embodiments, the memory includes program instructions executable by the at least one processor to define an articulation between the first physicalized object and the motion control user interface device, determine a motion path of the first physicalized object based on the motion signal, determine whether the second physicalized object is positioned along the motion path, and responsive to determining that the second physicalized object is not positioned along the motion path, applying a force to the first physicalized object to move the first physicalized object along the motion path.

In some embodiments, the program instructions further comprise instructions for responsive to determining that the second physicalized object is positioned along the motion path, applying a force to the first physicalized object to move the first physicalized object along the motion path to the second physicalized object.

In some embodiments, the database includes simulated physical properties of at least the first physicalized object and the second physicalized object, and wherein the memory includes program instructions executable by the at least one processor to move the first physicalized object relative to the second physicalized as determined by the simulated physical properties of the first physicalized object and the simulated physical properties of the second physicalized object.

In some embodiments, at least one of the first physicalized object and the second physicalized object is deflected as a result of an interaction between the first physicalized object and the second physicalized object or is stopped as a result of the interaction between the first physicalized object and the second physicalized object.

In some embodiments, the first physicalized object is simulated independently of the motion control user interface device. In some embodiments, the articulation is an elastic articulation and the force is an elastic force configured to pull the first physicalized object towards the motion control user interface device.

In some embodiments, the database includes designation of whether at least the first physicalized object and the second physicalized object are graspable objects, and wherein the memory includes program instructions executable by the at least one processor to define the articulation between the first physicalized object and the motion control user interface device in if the first physicalized object is a graspable object. In some embodiments, the second physicalized object is a graspable object or the second physicalized object is not a graspable object.

Some embodiments disclose a computer-implemented method for resolving spatial boundary conflicts of virtual objects using simulated spring constraints in 3D space. In some embodiments, the method includes defining a first simulated object that does not have a physical representation, the first simulated object corresponding to a motion control user interface device, defining a second simulated object that is a physicalized object having simulated physical properties, the second simulated object defined independently from the first simulated object, connecting the first physicalized object and the second physicalized object with an articulation, receiving a motion signal with the motion control user interface device, determining a motion path of the second simulated object based on the motion signal, and controlling movement of the second simulated object along the motion path based on the simulated physical properties of the second simulated object and the motion signal received by the motion control user interface device.

In some embodiments, the computer-implemented method further includes determining whether movement of the second simulated object along the motion path violates at least one boundary, responsive to determining that movement of the second simulated object along the motion path does not violate the at least one boundary, applying a force to the second simulated object to move the second simulated object along the motion path, and responsive to determining that movement of the second simulated object along the motion path violates the at least one boundary, applying a force to the second simulated object to move the second simulated object along the motion path to the at least one boundary.

In some embodiments, at least one of the second simulated object and the boundary is deflected as a result of an interaction between the second simulated object and the boundary or is stopped as a result of the interaction between the second simulated object and the boundary. In some embodiments, the articulation is an elastic articulation and the force is an elastic force configured to pull the second simulated object towards the motion control user interface device. In some embodiments, the elastic articulation is infinitely extensible after the elastic force exceeds a predetermined threshold.

Some embodiments include a computer-readable program product including program code, which when executed by a processor, causes an apparatus to perform defining an articulation between a physicalized object and a motion control user interface device that does not have a physical representation, receiving a motion signal with the motion control user interface device, determining a motion path of the physicalized object based on the motion signal, determining whether movement of the physicalized object along the motion path violates at least one boundary, and, responsive to determining that movement of the physicalized object along the motion path does not violate the at least one boundary, applying a force to the physicalized object to move the physicalized object along the motion path.

Some embodiments include a program code, which when executed by the processor, causes the apparatus to perform, responsive to determining that movement of the physicalized object along the motion path violates the at least one boundary, applying a force to the physicalized object to move the physicalized object along the motion path to the at least one boundary.

In some embodiments, the physicalized object includes simulated physical properties and the at least one boundary includes simulated physical properties, and wherein at least the physicalized object moves relative to the at least one boundary as determined by the simulated physical properties of the physicalized object and the simulated physical properties of the at least one boundary.

In some embodiments, at least one of the physicalized object and the at least one boundary is deflected as a result of an interaction between the physicalized object and the at least one boundary or is stopped as a result of the interaction between the physicalized object and the at least one boundary.

In some embodiments, the physicalized object is simulated independently of the motion control user interface device. In some embodiments, the articulation is an elastic articulation and the force is an elastic force configured to pull the physicalized object towards the motion control user interface device. In some embodiments, the elastic articulation is infinitely extensible after the elastic force exceeds a predetermined threshold.

Some embodiments include a computer-readable program product including program code, which when executed by a processor, causes an apparatus to perform defining a first simulated object that does not have a physical representation, the first simulated object corresponding to a motion control user interface device, defining a second simulated object that is a physicalized object having simulated physical properties, the second simulated object defined independently from the first simulated object, connecting the first physicalized object and the second physicalized object with an articulation, receiving a motion signal with the motion control user interface device, determining a motion path of the second simulated object based on the motion signal, and controlling movement of the second simulated object along the motion path based on the simulated physical properties of the second simulated object and the motion signal received by the motion control user interface device.

Some embodiments include a program code, which when executed by the processor, causes the apparatus to perform determining whether movement of the second simulated object along the motion path violates at least one boundary, responsive to determining that movement of the second simulated object along the motion path does not violate the at least one boundary, applying a force to the second simulated object to move the second simulated object along the motion path, and responsive to determining that movement of the second simulated object along the motion path violates the at least one boundary, applying a force to the second simulated object to move the second simulated object along the motion path to the at least one boundary.

In some embodiments, at least one of the second simulated object and the boundary is deflected as a result of an interaction between the second simulated object and the boundary or is stopped as a result of the interaction between the second simulated object and the boundary. In some embodiments, the articulation is an elastic articulation and the force is an elastic force configured to pull the second simulated object towards the motion control user interface device. In some embodiments, the elastic articulation is infinitely extensible after the elastic force exceeds a predetermined threshold.

Some embodiments disclose a computer-implemented method for manipulating objects beyond physical reach in 3D virtual environments by line of sight selection and application of a pull force. In some embodiments, the method includes emitting a grasping ray from a motion control user interface device, sweeping a simulated physical area for at least one simulated object with the grasping ray emitted by the motion control user interface device, determining whether the at least one simulated object is graspable, and responsive to determining that the at least one simulated object is graspable, attaching the motion control user interface device to the at least one simulated object using an articulation having a stretched position and a relaxed position, the articulation being in the stretched position when the motion control user interface device is attached to the at least one simulated object.

In some embodiments, the motion control user interface device is attached to the at least one simulated object in response to receiving a grasping command from the motion control user interface device. In some embodiments, the simulated object is outside of a physical reach of a user of the motion control user interface device. In some embodiments, the method includes applying a force along the articulation to pull the at least one simulated object towards the motion control user interface device.

In some embodiments, the articulation is an elastic articulation and the force is an elastic force exerted when the articulation contracts from the stretched position to the relaxed position. In some embodiments, the at least one simulated object is a physicalized object that includes simulated physical properties.

In some embodiments, the method includes determining whether the at least one simulated object is graspable by analyzing the simulated physical properties. In some embodiments, the articulation is an elastic articulation that exerts a force when contracting from the stretched position to the relaxed position, and further including the step of determining whether the at least one simulated object is graspable by analyzing the simulated physical properties and determining whether the force is strong enough to move the at least one simulated object based on the simulated physical properties.

Some embodiments disclose a system for manipulating objects beyond physical reach in 3D virtual environments by line of sight selection and application of a pull force. In some embodiments, the system includes a motion control user interface device configured to receive a motion signal and emit a grasping ray configured to identify at least one simulated object in a path of the grasping ray, and a computing device in electrical communication with the motion control user interface device and including at least one processor and a memory, the memory including a database including the at least one simulated object. In some embodiments, the memory includes program instructions executable by the at least one processor to determine whether the at least one simulated object is graspable, and responsive to determining that the at least one simulated object is graspable, attach the motion control user interface device to the at least one simulated object using an articulation having a stretched position and a relaxed position, the articulation being in the stretched position when the motion control user interface device is attached to the at least one simulated object.

In some embodiments, the motion control user interface device includes an input for receiving a grasping command, and wherein the memory includes program instructions executable by the at least one processor to attach the motion control user interface device to the at least one simulated object in response to receiving the grasping command from the motion control user interface device.

In some embodiments, the at least one simulated object is outside of a physical reach of a user of the motion control user interface device. In some embodiments, the memory includes program instructions executable by the at least one processor to apply a force along the articulation to pull the at least one simulated object towards the motion control user interface device.

In some embodiments, the articulation is an elastic articulation and the force is an elastic contracting force exerted when the articulation contracts from the stretched position to the relaxed position. In some embodiments, the at least one simulated object is a physicalized object and the database includes simulated physical properties of the at least one simulated object.

In some embodiments, the memory includes program instructions executable by the at least one processor to determine whether the at least one simulated object is graspable by analyzing the simulated physical properties.

In some embodiments, the articulation is an elastic articulation that exerts a force when moving from the stretched position to the relaxed position, and wherein the memory includes program instructions executable by the at least one processor to determine whether the at least one simulated object is graspable by analyzing the simulated physical properties and determining whether the force is strong enough to move the at least one simulated object based on the simulated physical properties.

Some embodiments disclose a computer-implemented method for manipulating objects beyond physical reach in 3D virtual environments by line of sight selection and application of a pull force. In some embodiments, the method includes emitting a ray from a motion control user interface device, sweeping a simulated physical area with the ray for at least one physicalized object that includes simulated physical properties, attaching an motion control user interface device to the physicalized object using an elastic connection having a stretched position and a relaxed position, the elastic connection exerting a force when contracting from the stretched position to the relaxed position, and determining whether the force is strong enough to move the at least one physicalized object by analyzing the simulated physical properties.

In some embodiments, the elastic connection is in the stretched position when the elastic connection is attached to the physicalized object. In some embodiments, the method includes contracting the elastic connection to move the physicalized object towards the motion control user interface device if the force is strong enough to move the at least one physicalized object. In some embodiments, the motion control user interface device is simulated independently from the physicalized object.

Some embodiments disclose a computer-readable program product including program code for manipulating objects beyond physical reach in 3D virtual environments by line of sight selection and application of a pull force, which when executed by a processor, causes an apparatus to perform emitting a grasping ray from a motion control user interface device, sweeping a simulated physical area for at least one simulated object with the grasping ray emitted by the motion control user interface device, determining whether the at least one simulated object is graspable, and, responsive to determining that the at least one simulated object is graspable, attaching the motion control user interface device to the at least one simulated object using an articulation having a stretched position and a relaxed position, the articulation being in the stretched position when the motion control user interface device is attached to the at least one simulated object.

In some embodiments, the motion control user interface device is attached to the at least one simulated object in response to receiving a grasping command from the motion control user interface device. In some embodiments, the simulated object is outside of a physical reach of a user of the motion control user interface device.

In some embodiments, the computer-readable program product including program code, when executed by a processor, causes an apparatus to perform applying a force along the articulation to pull the at least one simulated object towards the motion control user interface device. In some embodiments, the articulation is an elastic articulation and the force is an elastic force exerted when the articulation contracts from the stretched position to the relaxed position.

In some embodiments, the at least one simulated object is a physicalized object that includes simulated physical properties. In some embodiments, the computer-readable program product including program code, when executed by a processor, causes an apparatus to perform determining whether the at least one simulated object is graspable by analyzing the simulated physical properties.

In some embodiments, the articulation is an elastic articulation that exerts a force when contracting from the stretched position to the relaxed position, and further including the step of determining whether the at least one simulated object is graspable by analyzing the simulated physical properties and determining whether the force is strong enough to move the at least one simulated object based on the simulated physical properties.

Some embodiments disclose a computer-readable program product including program code for manipulating objects beyond physical reach in 3D virtual environments by line of sight selection and application of a pull force, which when executed by a processor, causes an apparatus to perform emitting a ray from a motion control user interface device, sweeping a simulated physical area with the ray for at least one physicalized object that includes simulated physical properties, attaching an motion control user interface device to the physicalized object using an elastic connection having a stretched position and a relaxed position, the elastic connection exerting a force when contracting from the stretched position to the relaxed position, and determining whether the force is strong enough to move the at least one physicalized object by analyzing the simulated physical properties.

In some embodiments, the elastic connection is in the stretched position when the elastic connection is attached to the physicalized object. In some embodiments, the computer-readable program product including program code, when executed by a processor, causes an apparatus to perform contracting the elastic connection to move the physicalized object towards the motion control user interface device if the force is strong enough to move the at least one physicalized object. In some embodiments, the motion control user interface device is simulated independently from the physicalized object.

Some embodiments disclose a computer-implemented method for manipulating objects in 3D virtual space via an anchor point. In some embodiments, the method includes defining a simulated object as being attached to an anchor point of a simulated motion control user interface device representative of a physical motion control user interface device, moving the simulated object in a first direction in which movement the simulated object with the simulated motion control user interface device in response to a change in an orientation of the physical motion control user interface device, and moving the simulated object in a second direction in response to a command input using a command interface of the physical motion control user interface device.

In some embodiments, the simulated object is moved in the second direction by moving the anchor point with respect to the simulated motion control user interface device. In some embodiments, motion of the simulated object in the second direction is not dependent on the change in the orientation of the physical motion control user interface device.

In some embodiments, the motion in the second direction is directly correlated with actuation of the command input of the physical motion control user interface device. In some embodiments, the motion in the second direction is indirectly correlated with actuation of the command input when the command input is a boundary of the command interface of the physical motion control user interface device.

In some embodiments, the motion in the first direction is about an axis and the motion in the second direction is about the axis. In some embodiments, the motion in the first direction is about a first axis and the motion in the second direction is about a second axis different than the first axis. In some embodiments, the motion in the first direction and the motion in the second direction are additive. In some embodiments, the motion in the second direction accelerates in response to a rate of actuation of the command interface of the physical motion control user interface device.

In some embodiments, the simulated object is simulated independently of the simulated motion control user interface device and the anchor point is simulated dependent on the simulated motion control user interface device, and wherein the simulated object is a physicalized object that includes simulated physical properties and the simulated motion control user interface device is not a physicalized object.

Some embodiments disclose a system for manipulating objects in 3D virtual space via an anchor point. In some embodiments, the system, includes a physical motion control user interface device, and a computing device in electrical communication with the physical motion control user interface device and including at least one processor and a memory. In some embodiments, the memory including program instructions executable by the at least one processor to define a simulated object as being attached to an anchor point of a simulated motion control user interface device representative of the physical motion control user interface device, responsive to a change in an orientation of the physical motion control user interface device, move the simulated object in a first direction, and responsive to receiving a command input with a command interface of the physical motion control user interface device, moving the simulated object in a second direction.

In some embodiments, the memory includes program instructions executable by the at least one processor to move in the second direction by moving the anchor point with respect to the simulated motion control user interface device. In some embodiments, motion of the simulated object in the second direction is not dependent on the change in the orientation of the physical motion control user interface device. In some embodiments, the motion in the second direction is directly correlated with actuation of the command input of the physical motion control user interface device.

In some embodiments, the motion in the second direction is indirectly correlated with actuation of the command input when the command input is at a boundary of the command interface of the physical motion control user interface device. In some embodiments, the motion in the first direction is about an axis and the motion in the second direction is about the axis.

In some embodiments, the motion in the first direction is about a first axis and the motion in the second direction is about a second axis different than the first axis. In some embodiments, the motion in the first direction and the motion in the second direction are additive. In some embodiments, the motion in the second direction accelerates in response to a rate of actuation of the command interface of the physical motion control user interface device.

In some embodiments, the memory includes program instructions executable by the at least one processor to simulate the simulated object independently of the simulated motion control user interface device and to simulate the anchor point as dependent on the simulated motion control user interface device and wherein the simulated object is a physicalized object that includes simulated physical properties and the simulated motion control user interface device is not a physicalized object.

Some embodiments disclose a computer-readable program product including program code for manipulating objects in 3D virtual space via an anchor point, which when executed by a processor, causes an apparatus to perform defining a simulated object as being attached to an anchor point of a simulated motion control user interface device representative of a physical motion control user interface device, moving the simulated object in a first direction in which movement the simulated object with the simulated motion control user interface device in response to a change in an orientation of the physical motion control user interface device, and moving the simulated object in a second direction in response to a command input using a command interface of the physical motion control user interface device.

In some embodiments, the simulated object is moved in the second direction by moving the anchor point with respect to the simulated motion control user interface device. In some embodiments, motion of the simulated object in the second direction is not dependent on the change in the orientation of the physical motion control user interface device.

In some embodiments, the motion in the second direction is directly correlated with actuation of the command input of the physical motion control user interface device. In some embodiments, the motion in the second direction is indirectly correlated with actuation of the command input when the command input is a boundary of the command interface of the physical motion control user interface device. In some embodiments, the motion in the first direction is about an axis and the motion in the second direction is about the axis. In some embodiments, the motion in the first direction is about a first axis and the motion in the second direction is about a second axis different than the first axis.

In some embodiments, the motion in the first direction and the motion in the second direction are additive. In some embodiments, the motion in the second direction accelerates in response to a rate of actuation of the command interface of the physical motion control user interface device.

In some embodiments, the simulated object is simulated independently of the simulated motion control user interface device and the anchor point is simulated dependent on the simulated motion control user interface device, and wherein the simulated object is a physicalized object that includes simulated physical properties and the simulated motion control user interface device is not a physicalized object.

In the context of this specification, therefore, a special purpose computer or similar special purpose electronic computing device is capable of manipulating or transforming signals, typically represented as physical electronic or magnetic quantities within memories, registries, or other information storage devices, transmission devices, or display devices of the special purpose computer or similar special purpose electronic computing device. The use of the variable “n” is intended to indicate that a variable number of local computing devices may be in communication with the network. In any disclosed embodiment, the terms “generally” and “approximately” may be substituted with “within a percentage of” what is specified, where the percentage includes 0.1, 1, 5, and 10 percent.

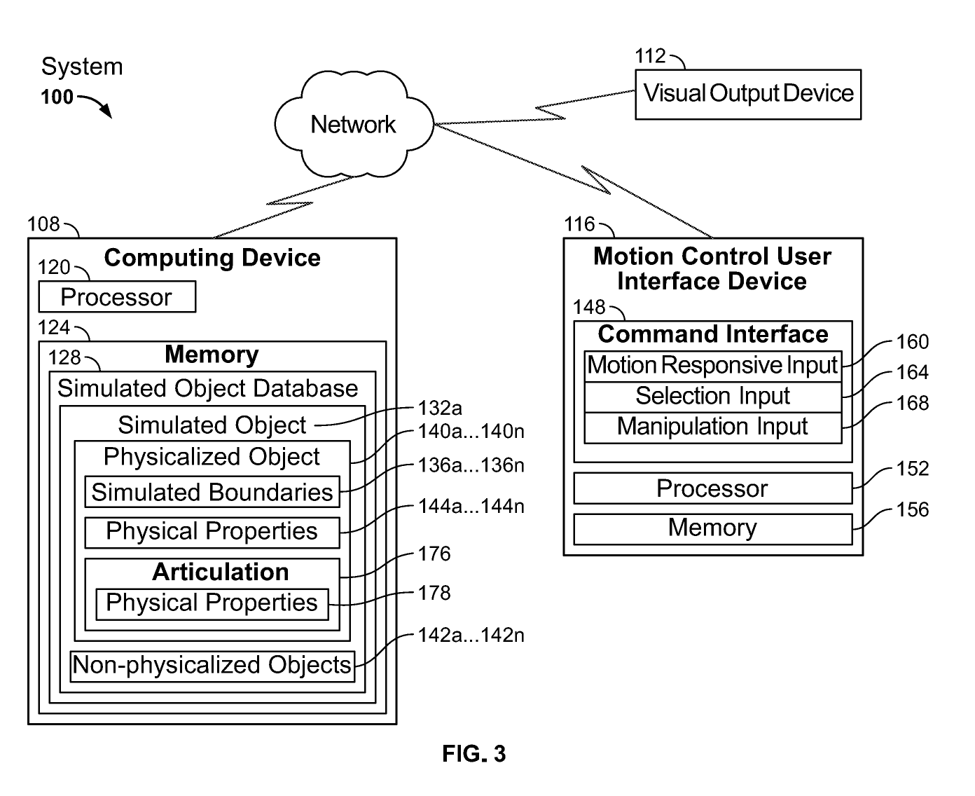

FIG. 3 illustrates a system 100 for generating a three-dimensional virtual space 104 according to some embodiments of the present disclosure. The three-dimensional virtual space 104 defines a virtual world space defined by X-, Y- and Z-coordinate axes. The system 100 includes a computing device 108, a visual output device 112, and a physical motion control user interface device 116. The computing device 108, the physical motion control user interface device 116, and the visual output device 112 are in either in wireless communication over a network or in wired electrical communication.

The computing device 108 includes a processor 120 and a memory 124. The memory 124 includes a simulated object database 128. The simulated object database 128 includes simulation data for simulated objects 132a-132n included in the three-dimensional virtual spaces 104, 180, 224, and 276. In the illustrated embodiment, the simulated objects 132a-132n are defined by simulated boundaries 136a-136n. The simulated objects 132a-132n may be fixed objects, such as walls or floors, or may be movable objects. The simulated objects 132a-132n may have defined shape and dimensions. Within the simulated object database 128, the simulated objects 132a-132n are categorized as physicalized objects 140a-140n or non-physicalized objects 142a-142n. The physicalized objects 140a-140n are simulated objects that have a physical representation in the three-dimensional virtual space 104 and are assigned physical properties 144a-144n that are stored in the simulated object database 128. Exemplary physical properties may include weight, mass, coefficient of static friction, coefficient of kinetic friction, density, stiffness, and boundary characteristics. Exemplary boundary characteristics include behavior of the boundaries 136a-136n, such as whether the boundaries 136a-136n of the simulated physicalized objects 140a-140n are deformable or non-deformable. The physicalized objects 140a-140n are also characterized as graspable or non-graspable in the simulated object database 128. The term “graspable” is generally used herein to refer to simulated objects that may be picked up, repositioned, and/or manipulated using the motion control user interface device 116. The non-physicalized objects 142a-142n do not have a physical representation in the three-dimensional virtual space 104. The non-physicalized objects 142a-142n may be characterized as graspable or non-graspable in the simulated object database 128.

The simulated objects 132a-132n each define a local space defined by local X-, Y-, and Z-coordinate axes that are oriented relative to a reference position in the virtual world space. As will be described in more detail below, although the simulated objects 132a-132n may be picked up, repositioned and/or manipulated in response to user commands input using the physical motion control user interface device 116, the simulated objects 132a-132n are defined within the world space independently of the simulated motion control user interface device 116′. The simulated objects 132a-132n may be each independently define local spaces that may be repositioned with respect to the virtual world space. In some embodiments, the simulated objects 132a-132n may further include dependent child simulated objects that are connected to and repositionable with the simulated objects 132a-132n. The dependent child simulated objects may also be repositionable with respect to the simulated objects 132a-132n. The memory 124 of the computing device 108 includes program instructions executable by the processor 120 to conduct a world-space transformation to reposition the simulated objects 132a-132n and their corresponding associated local spaces with respect to the virtual world space as described in more detail below.

The visual output device 112 is in electronic communication with the computing device 108 and adapted to display the simulated three-dimensional virtual space 104 to a user. Exemplary embodiments of the visual output device 112 may include goggles, a computer monitor, a projector, a television screen, or any output device capable of visually displaying the three-dimensional virtual space 104 to a user.

The physical motion control user interface device 116 includes a command interface 148, a processor 152, and a memory 156. The command interface 148 includes at least a motion-responsive input 160, a selection input 164, and a manipulation input 168. The motion-responsive input 160 is configured to sense a change in a physical orientation (e.g. translation or rotation) of the physical motion control user interface device 116 and sends a signal indicative of the sensed change in physical orientation to the computing device 108. The selection input 164 is operable by a user to issue commands such as grasping and releasing of the simulated objects 132a-132n. Exemplary selection inputs may include a button or a trigger physically actuable by a user. The manipulation input 168 is physically manipulable by a user to change an orientation of the grasped simulated object 132a-132n in the three-dimensional virtual space 104. In some embodiments, the manipulation input 168 is operable to rotate the grasped simulated object 132a-132n. Exemplary manipulation inputs may include a joystick or a touch pad.

In the illustrated construction, the physical motion control user interface device 116 is simulated as a non-physicalized object. Throughout this disclosure, a simulated representation of the physical motion control user interface device 116 is indicated using the prime symbol “′”. The simulated motion control user interface device 116′ moves through the three-dimensional virtual space 104 in response to the changes in physical orientation of the physical motion control user interface device 116 as the physical motion control user interface device 116 is moved by the user in the physical space. The simulated motion control user interface device 116′ defines a local space defined by local X-, Y-, and Z-coordinate axes that is oriented relative to a reference position in the virtual world space. The local space defined by the simulated motion control user interface device 116′ may be repositioned with respect to the virtual world space. For example, the memory 124 of the computing device 108 includes program instructions executable by the processor 120 to conduct a world-space transformation to reposition the simulated motion control user interface device 116′ and its associated local space with respect to the virtual world space in response to command signals received by the motion-responsive input 160.

In some embodiments, an anchor point 172 is simulated at an end of the simulated motion control user interface device 116′. The anchor point 172 is a simulated object that is dependent on (e.g. is a child object of) the simulated motion control user interface device 116′. Since the anchor point 172 is a child of the simulated motion control user interface device 116′ and the simulated motion control user interface device 116′ is a non-physicalized object, the anchor point is also a non-physicalized object. Since the anchor point 172 is dependent on the simulated motion control user interface device 116′, the anchor point 172 is repositioned within the virtual world space whenever the simulated motion control user interface device 116′ is repositioned within the virtual world space. The simulated motion control user interface device 116′ defines a local space defined by local X-, Y-, and Z-coordinate axes that is oriented relative to a reference position in the virtual world space. The local space defined by the anchor point 172 may be repositioned relative to the local space defined by the simulated motion control user interface device 116′. For example, the memory 124 of the computing device 108 includes program instructions executable by the processor 120 to conduct a world-space transformation to reposition the simulated motion control user interface device 116′ and its associated local space with respect to the virtual world space in response to input received by the manipulation input 168. A second world space transformation may be used to orient the anchor point 172 with respect to the world space.

The simulated motion control user interface device 116′ or the anchor point 172 may be connected to the simulated objects 132a-132n using an articulation 176. In the illustrated construction, the articulation 176 is formed between the end of the simulated motion control user interface device 116′ and a point on the simulated object 132a-132n. In some embodiments, the articulation 176 is attached to a center of the simulated objects 132a-132n (e.g. within the boundaries 136a-136n of the simulated object 132a-132n). In other embodiments, the articulation 176 may be positioned on other locations of the simulated objects 132a-132n.

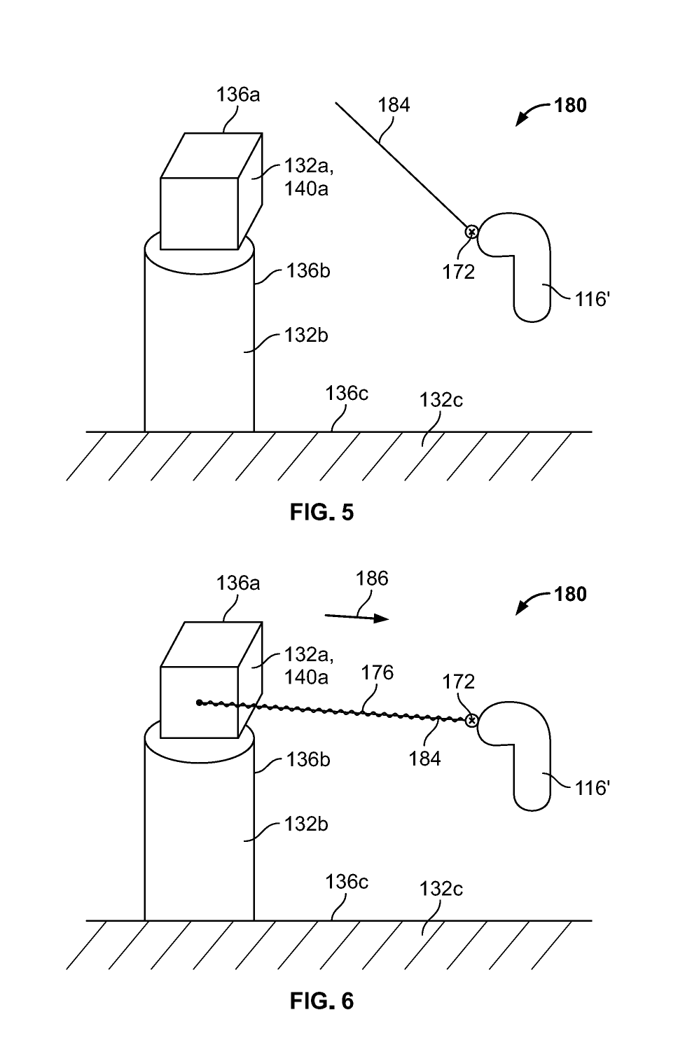

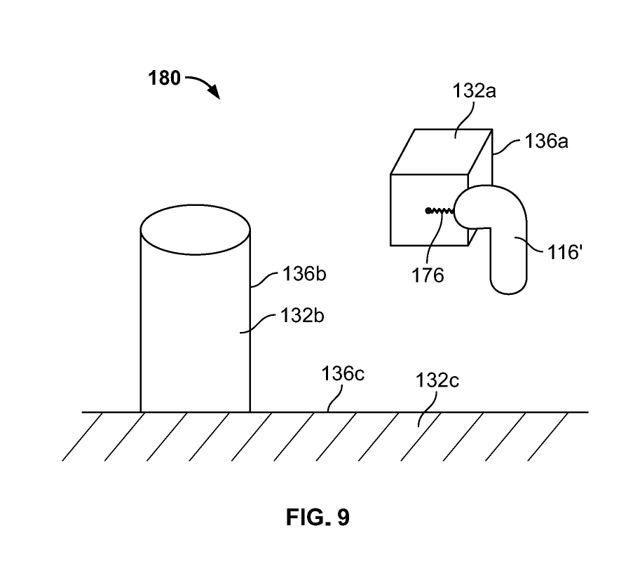

The articulation 176 is configured to regulate relative orientation of the simulated object 132a-132n with respect to motion control user interface device 116′ or the anchor point 172. The articulation is continuously repositionable between an extended position (FIG. 5) and a contracted position (FIGS. 8 and 9). In some embodiments, the articulation 176 is elastic and the extended position is a stretched position. In some embodiments, the articulation 176 is infinitely extendible or stretchable (e.g. there may be no limitation on the displacement of the stretched position relative to the contracted position). In other embodiments, the articulation 176 may be configured to break after the extended position exceeds a predetermined length-based breaking threshold. In embodiments in which the articulation 176 is elastic, the articulation 176 may be configured to break after a simulated force required to position the articulation 176 in the extended position has exceed a predetermined force-based breaking threshold. In embodiments in which the articulation 176 is elastic, the articulation 176 may be modeled by a spring. The articulation 176 is configured to have a length of approximately zero when the articulation 176 is in the contracted position. The articulation 176 is configured to exert a force when contracting from the extended position to the contracted position. As is described in more detail below, the force exerted during contraction of the articulation 176 may be used to pull simulated objects 132a-132n towards the simulated motion control user interface device 116′ or the anchor point 172.

In some embodiments, the articulation 176 may be modeled as a physicalized object and have physical properties 178 that may be specified by the user. In addition to the physical properties described above with respect to the physicalized objects 140a-140n, exemplary physical properties of the articulation 176 may also include a spring constant, the predetermined length-based breaking threshold and the predetermined force-based breaking threshold. For example, the user may specify the spring constant of the articulation 176 to specific desired simulated behavior of the articulation 176. Exemplary simulated behaviors of the articulation 176 include pitch, yaw, rate of elastic contraction, and force exerted during contraction. In some embodiments, the spring constant may be configured to reduce the effect of physical shaking of the user's hand while the user is holding the physical motion control user interface device 116 on the motion of the simulated objects 132a-132n in the three-dimensional virtual space 104. In such embodiments, the spring constant may be specified to be too high for the articulation 176 to move in response to physical shaking of the user's hand. In embodiments in which the articulation 176 is not a spring, the physical properties 178 of the articulation 176 may include an amount of elasticity, which may be specified as described above with respect to the spring constant.

When the simulated motion control user interface device 116′ or the anchor point 172 is connected to the simulated objects 132a-132n using the articulation 176, changes in the position and/or orientation of the simulated motion control user interface device 116′ or the anchor point 172 are transmitted to the simulated object 132a-132n through the articulation 176. Since the changes in the position and/or orientation of the simulated motion control user interface device 116′ or the anchor point 172 are transmitted to the simulated object 132a-132n through the articulation 176, the position and/or orientation of the simulated physical object 140a-140n may be changed in response to movement of the physical motion control user interface device 116 and/or the manipulation input 168 without requiring the simulated objects 132a-132n to be simulated dependent on the simulated motion control user interface device 116′. Since the simulated objects 132a-132n are independent of the simulated motion control user interface device 116′ and/or the anchor point 172, the simulated objects 132a-132n may be physicalized objects 140a-140n and the simulated motion control user interface device 116′ and/or the anchor may be non-physicalized objects 142a-142n.

When the articulation 176 is attached between the simulated object 132a-132n and the simulated motion control user interface device 116′ or the anchor point 172, simulated object 132a-132n behaves as if the simulated object 132a-132n is held by the motion control user interface device 116′ or the anchor point 172.

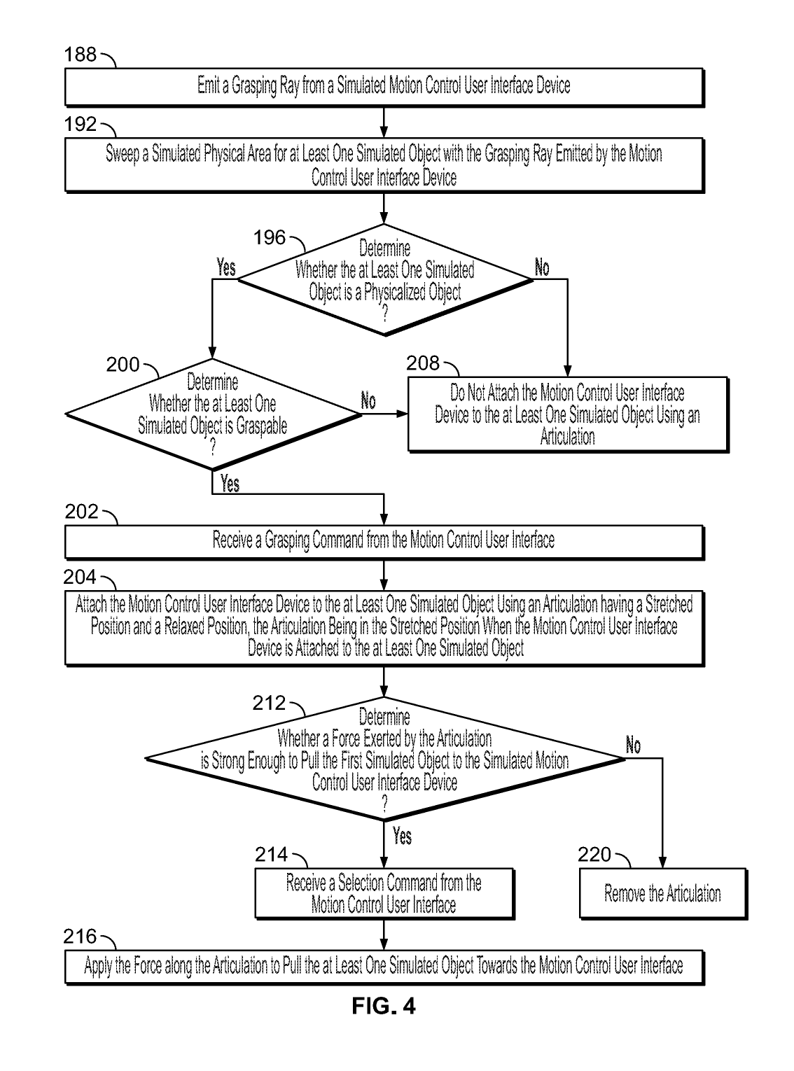

FIGS. 4-9 illustrate a process for attaching the articulation 176 to the simulated object 132a-132n and contracting the articulation 176 so that the simulated object 132a-132n is adjacent the simulated motion control user interface device 116′. When the simulated object 132n-132n is attached to the simulated motion control user interface device 116′ or the anchor point 172 and positioned adjacent the simulated motion control user interface device 116′ or the anchor point 172, the simulated object 132a-132n behaves as if it is held by the simulated motion control user interface device 116′ or the anchor point 172.

FIG. 5 illustrates a three-dimensional virtual space 180 including a first simulated object 132a, a second simulated object 132b, a third simulated object 132c, and the simulated motion control user interface device 116′. As is shown in FIG. 5, the first simulated object 132a is supported by the second simulated object 132b, which is in turn supported by the third simulated object 132c. In the process of FIGS. 4-9, at least one of the simulated objects 132a-132c is a physicalized object, and the other simulated objects 132a-132c may either be physicalized objects or non-physicalized objects. By way of non-limiting example, for ease of explanation, the first simulated object 132a is described as a physicalized object in the embodiment of FIGS. 4-9. In the illustrated embodiment, the simulated motion control user interface device 116′ includes the anchor point 172. However, the process of FIGS. 4-9 does not require the anchor point 172.

As shown in FIGS. 4 and 5, the simulated motion control user interface device 116′ emits a grasping ray 184 (block 188). The grasping ray 184 may be emitted in response to motion of the motion control user interface device 116 when the simulated motion control user interface device 116′ is not engaged to the simulated object 132a-132n, or the grasping ray 184 may be emitted in response to a user actuating the selection input 164. The user actuates the physical motion control user interface device 116 to sweep the grasping ray 184 over the simulated objects 132a-132n (block 192). When the grasping ray 184 engages the simulated object 132a-132n, the computing device 108 determines whether the simulated object 132a-132n is the physicalized object 140a-140n or the non-physicalized objects 142a-142n (block 196). If the simulated object 132a-132n is the physicalized object 140a-140n, the computing device accesses the simulated object database 128 to determine whether the simulated object 132a-132n is graspable (block 200). In some embodiments, the simulated object database 128 indicates whether the simulated object 132a-132n is graspable or non-graspable. In other embodiments, the computing device 108 retrieves the physical properties 144a-144n of the simulated object 132a-132n from the simulated object database 128 and analyzes the physical properties 144a-144n to determine whether the simulated object 132a-132n is graspable. If the simulated object 132a-132n is graspable, the articulation 176 is formed between the simulated motion control user interface device 116′ or the anchor point 172 and the simulated object 132a-132n (block 204). Since the simulated object 132a-132n is spaced from the simulated motion control user interface device 116′ or the anchor point 172, the articulation 176 is formed in the stretched position. In some embodiments, the articulation 176 is formed automatically after completion of block 200. In other embodiments, the user must actuate the selection input 164 before the articulation 176 is formed. If the simulated object 132a-132n is not graspable, the articulation 176 is not formed. If the simulated object 132a-132n is the non-physicalized object 142a-142n, the articulation 176 is not formed (block 208).

FIG. 6 shows the three-dimensional virtual space 180 after the first simulated object 132a has been identified as the one of the physicalized objects 140a-140n and the articulation 176 has been formed between the first simulated object 132a and the simulated motion control user interface device 116′ or the anchor point 172. Since the first simulated object 132a is spaced from the simulated motion control user interface device 116′ or the anchor point 172, the articulation 176 is formed in the stretched position. With continued reference to FIGS. 4 and 6, after the articulation 176 has been formed between the first simulated object 132a and the simulated motion control user interface device 116′ or the anchor point 172 as shown by an arrow 186, the computing device analyzes the physical properties 144a-144n of the first simulated object 132a and the articulation 176 to determine whether the force exerted as the articulation 176 contracts from the extended position to the contracted position is strong enough to pull the first simulated object 132a to the simulated motion control user interface device 116′ or the anchor point 172 as shown by the arrow 186 (block 212). For example, in the embodiment of FIG. 6, the computing device 108 may retrieve the static friction coefficient, the kinetic friction coefficient, and the mass of the first simulated object 132a to determine whether the force exerted by the articulation 176 is strong enough to overcome static and/or kinetic friction between the first simulated object 132a and the second simulated object 132b. The computing device 108 may also retrieve the weight of the first simulated object 132a from the simulated object database 128 to determine whether the force exerted by the articulation 176 is strong enough to pull the first simulated object 132a to the simulated motion control user interface device 116′ or the anchor point 172 as shown by the arrow 186.

Referring again to FIG. 4, if the force exerted by the articulation 176 as the articulation 176 contracts is strong enough to pull the simulated objects 132a-132n towards the simulated motion control user interface device 116′ or the anchor point 172 as shown by the arrow 186, the computing device 108 contracts the articulation 176 to the contracted position to pull the simulated objects 132a-132n towards the simulated motion control user interface device 116′ or the anchor point 172 as shown by the arrow 186 (block 216). In some embodiments, the articulation 176 contracts automatically after completion of block 212. In other embodiments, the articulation 176 may not contract until the user has commanded the articulation 176 to contract using the selection input 164. If the force exerted by the articulation 176 as the articulation 176 contracts is not strong enough to pull the first simulated object 132a towards the simulated motion control user interface device 116′ or the anchor point 172, the articulation 176 is removed (block 220).

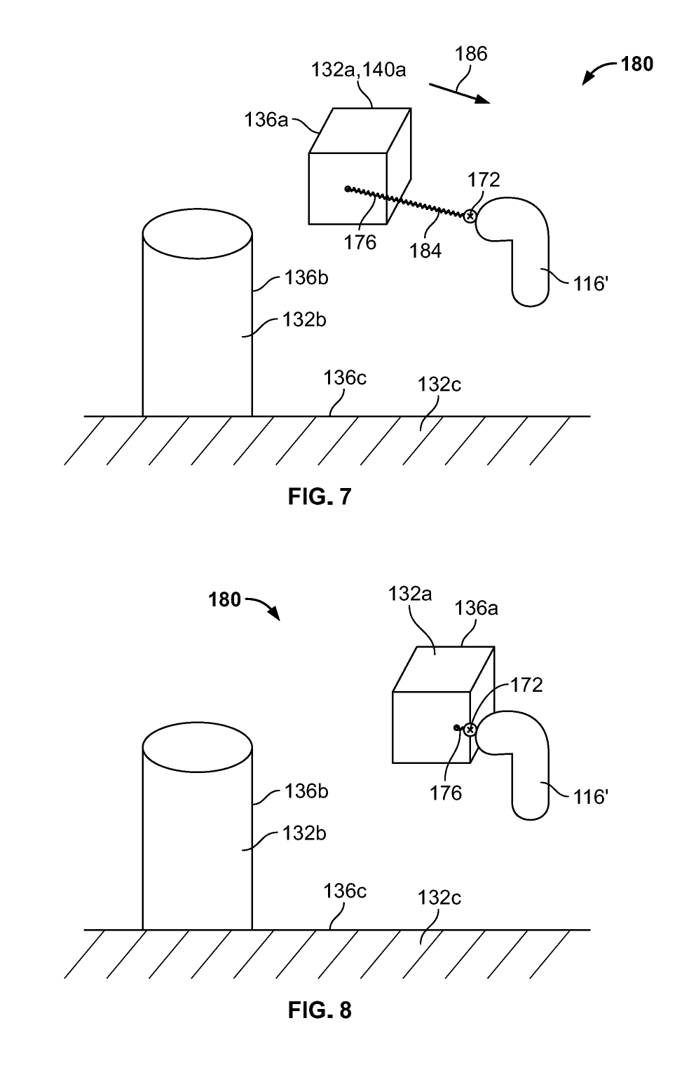

FIG. 7 shows the three-dimensional virtual space 180 as the first simulated object 132a is being pulled towards the simulated motion control user interface device 116′ or the anchor point 172 as shown by the arrow 186. The articulation 176 is shown supporting the weight of the first physicalized object 140 as the articulation 176 contracts to pull first physicalized object 140 is being pulled towards the simulated motion control user interface device 116′ or the anchor point 172 as shown by the arrow 186.

FIGS. 8 and 9 show the first simulated object 132a, the articulation 176, and the simulated motion control user interface device 116′ when the articulation 176 is in the contracted position. FIG. 8 illustrates an embodiment in which the simulated motion control user interface device 116′ includes the anchor point 172. The first simulated object 132a is connected to the anchor point 172 through the articulation 176. In FIG. 8, the articulation 176 is in the contracted position, so the length of the articulation 176 is generally zero. FIG. 9 illustrates an embodiment in which the simulated motion control user interface device 116′ does not include the anchor point 172. The first simulated object 132a is connected to the simulated motion control user interface device 116′ through the articulation 176. In FIG. 9, although the articulation 176 is in the contracted position and the length of the articulation 176 is generally zero, the length of the articulation 176 has been exaggerated to show the connectivity between the first simulated object 132a and the simulated motion control user interface device 116′.

In an exemplary embodiment of the process of FIGS. 4-9 in which the second simulated object 132b is one of the physicalized objects 140a-140n, after completion of block 212 the computing device may access the simulated object database 128 to retrieve the physical properties 144a-144n of the second simulated object 132b to determine the effect of pulling the first simulated object 132a along the second simulated object 132b. Depending on the relative physical properties 144a and 144b of the first simulated object 132a and the second simulated object 132b, the second simulated object 132b may not be effected by pulling the first simulated object 132a along the second simulated object 132b, the second simulated object 132b may be displaced laterally by the first simulated object 132a, or the second simulated object 132b may be displaced angularly by the first simulated object 132a, or the second simulated object 132b may be displaced both laterally and angularly by the first simulated object 132a.

In another exemplary embodiment of the process of FIGS. 4-9, both the second simulated object 132b and the third simulated object 132c are physicalized objects 140a-140n. In such an embodiment, the user may command the simulated motion control user interface device 116′ to emit the grasping ray 184 and may move the physical motion control user interface device 116 to sweep the grasping ray 184 within the three-dimensional virtual space 180. When the grasping ray 184 encounters the third simulated object 132c, the computing device 108 accesses the simulated object database 128 to determine whether the third simulated object 132c is one of the physicalized objects 140a-140n. The computing device 108 then accesses the simulated object database 128 to determine whether the third simulated object 132c is graspable. The computing device 108 determines that the third simulated object 132c is not graspable, so the articulation 176 is not formed between the third simulated object 132c and the simulated motion control user interface device 116′ or the anchor point 172.

The user continues moving the physical motion control user interface device 116 to sweep the grasping ray 184 within the three-dimensional virtual space 180. When the grasping ray 184 encounters the second simulated object 132b, the computing device 108 accesses the simulated object database 128 to determine whether the second simulated object 132b is one of the physicalized objects 140a-140n. The computing device 108 then accesses the simulated object database 128 to determine whether the second simulated object 132b is graspable. After determining that the second simulated object 132b is graspable, the computing device 108 retrieves at least the physical properties 144b of the second simulated object 132b and the physical properties 178 of the articulation 176 from the simulated object database 128. In some embodiments, the computing device 108 may include program instructions for determining whether the selected simulated object 132b is positioned adjacent, supported by, or supporting any other simulated objects 132a-132n. In such an embodiment, if the adjacent, supported by, or supporting simulated objects 132a-132n are physicalized objects 140a-140n, the computing device 108 retrieves the physical properties 144a-144n from the simulated object database 128. For example, as shown in FIG. 5-9, the second simulated object 132b supports the first simulated object 132a and is supported by the third simulated object 132c. The computing device 108 then analyzes the physical properties 144a-144c of the simulated objects 132a-132n and the physical properties 178 of the articulation 176 to determine whether the force exerted when the articulation 176 is contracted is capable of pulling the second simulated object 132b. If the articulation 176 is capable of pulling the second simulated object 132b, the computing device 108 analyzes the physical properties 144a-144c of the simulated objects 132a-132c and the physical porperties 178 of the articulation 176 to determine how the simulated objects 132a-132c move as the second simulated object 132b is pulled by the articulation 176.

The process shown and described in FIGS. 4-9 allows a user to select simulated objects 132a-132n in the three-dimensional virtual space, attach the articulation 176 between the selected simulated object 132a-132n and the simulated motion control user interface device 116′ or the anchor point 172, and then contract the articulation 176 to pull the simulated object 132a-132n to the simulated motion control user interface device 116′ or the anchor point 172. Stated another way, the process shown and described in FIGS. 4-9 allows user to grasp the simulated object 132a-132n without bringing the simulated motion control user interface device 116′ into close proximity to the simulated object 132a-132n. Accordingly, the process shown and described in FIGS. 4-9 allows a user to pick up simulated objects 132a-132n that are beyond the user's physical reach. For example, in order to pick up a simulated object that is located beneath the physical motion control user interface device 116 held in the user's hand, the user can use the process of FIGS. 4-9 to pick up the simulated object 132a-132n without bending down. Similarly, if the simulated object 132a-132n is laterally spaced from the user, the user can use the process of FIGS. 4-9 to grasp the object without physically walking to bring the simulated motion control user interface device 116′ adjacent the simulated object 132a-132n. Accordingly, the process of FIGS. 4-9 is particularly helpful if the user cannot make the physical motions necessary to position the simulated motion control user interface device 116′ adjacent the simulated object 132a-132n. For example, a user positioned in a small physical area such as a small room will not be limited in the three-dimensional virtual space 180 by the size limitations of the small physical area in which the user is positioned.

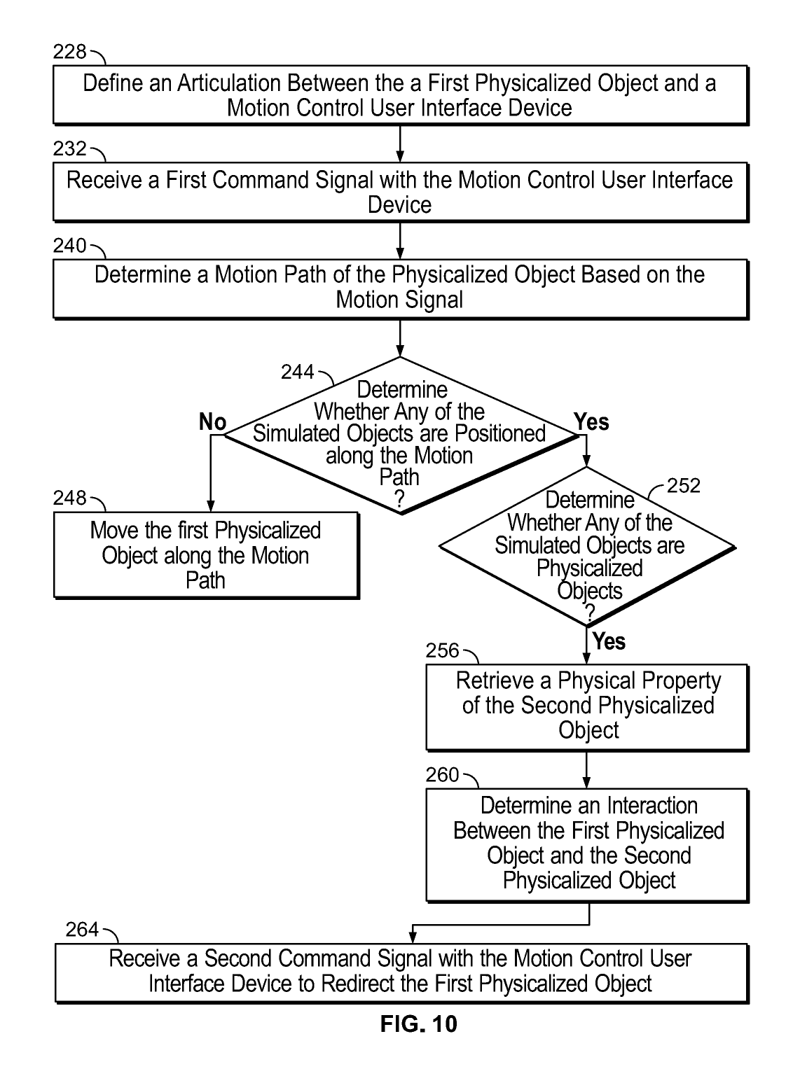

FIGS. 10-13 illustrate a process for simulating behavior of a first physicalized object 140a attached to the simulated motion control user interface device 116′ attached with the articulation 176 in the presence of physicalized obstacles, such as the physicalized objects 140b-140n, positioned in a three-dimensional virtual space 224. In the process of FIGS. 10-13, the first physicalized object 140a may have attached to the simulated motion control user interface device 116′ or the anchor point 172 using the method described in FIGS. 4-9. In the illustrated embodiment, the first simulated object 132a is a physicalized object and the simulated motion control user interface device 116′ or the anchor point 172 is a non-physicalized object. The first simulated object 132a is simulated independently of (e.g. is not a child object of) the simulated motion control user interface device 116′ or the anchor. Since the motion control user interface device 116′ and the anchor point 172 are non-physicalized objects 142a-142n, the simulated motion control user interface device 116′ or the anchor point 172 may pass through any obstacles they encounter. In contrast, since the first physical object 140a includes the physical properties 144a, the first physical object 140a will collide with the boundaries 136a-136n of any physicalized objects 140b-140n that are obstacles in the first physicalized object's 140a path.

With reference to FIG. 10, as an initial step, the articulation 176 is defined between a first simulated object 132a and the simulated motion control user interface device 116′ or the anchor (block 228). The motion-responsive input 160 of the physical motion control user interface device 116 then receives a command signal from the user (block 232). In response to receiving the command signal from the user, the computing device 108 retrieves the physical properties 144a of the first simulated object 132a and the articulation 176 from the simulated object database 128 and calculates a motion path 236 for the first simulated object 132a (block 240). After calculating the motion path 236, the computing device 108 analyzes the relative positions of the first simulated object 132a and the simulated objects 132b-132n to determine whether any of the simulated objects 132b-132n are positioned along the motion path 236 (block 244). If none of the simulated objects 132b-132n are positioned along the motion path 236, the computing device 108 moves the first simulated object 132a along the motion path 236 as required by the command signal (block 248). If any of the simulated objects 132b-132n is positioned along the motion path 236, the computing device 108 accesses the simulated object database 128 to determine wither the simulated objects 132b-132n positioned along the motion path 236 are physicalized objects (block 252). If the simulated objects 132b-132n positioned along the motion path 236 are physicalized objects, the computing device 108 retrieves the physical properties 144b-144n of the simulated objects 132b-132n (block 256). The computing device 108 then analyzes the motion path 236, the physical properties 144a of the first simulated object 132a, the articulation 176, and the physical properties 144b-144n of the simulated objects 132b-132n to determine how the first simulated object 132a will interact with the simulated objects 132b-132n positioned along the motion path 236 (block 260). In some embodiments, the simulated objects 132b-132n may stop the first simulated object 132a, the first simulated object 132a may travel along the boundaries 136b-136n of the simulated objects 132b-132n, the first simulated object 132a may deflect off of the simulated objects 132b-132n, the simulated objects 132b-132n may defect off of the first simulated object 132a, or the first simulated object 132a and the simulated objects 132b-132n may mutually deflect. The user may then send a second command signal using the manipulation input 168 of the motion control user interface device 116 to redirect the first simulated object 132a (block 264). For example, the second command signal may cause the first simulated object 132a to move along the boundary 136b-136n of a fixed simulated object 132b-132n until the first simulated object 132a reaches an end of the boundary 136b-136n or the command signal may redirect the first simulated object 132a to compensate for deflection.

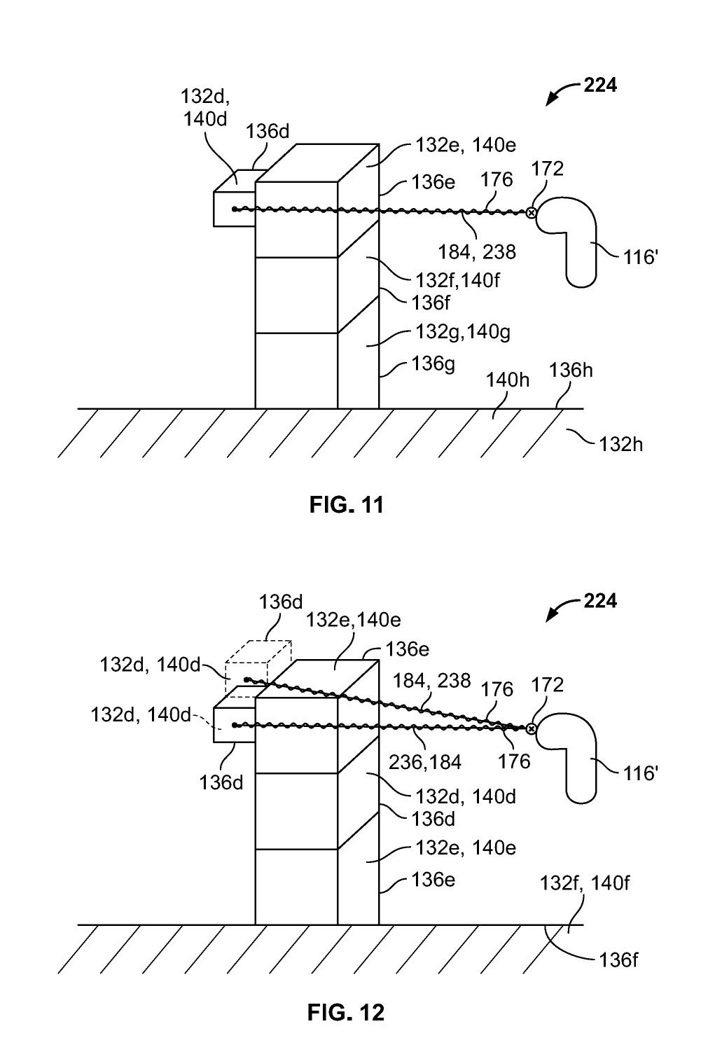

FIG. 11 illustrates a three-dimensional virtual space 268 including a first simulated object 132d, a second simulated object 132e, a third simulated object 132f, a fourth simulated object 132g, a fifth simulated object 132h, and the simulated motion control user interface device 116′. By way of non-limiting example, the first simulated object 132d and the second simulated object 132e are physicalized objects. The simulated objects 132b-132n may either be physicalized objects or non-physicalized objects. In other embodiments, different combinations of the simulated objects 132d-132h may be physicalized objects or non-physicalized objects as long as the simulated object 132d-132h attached to the simulated motion control user interface device 116′ is a physicalized object and least one of the other objects 132d-132h is a physicalized object. As is shown in FIG. 11, the first simulated object 132d is attached to the simulated motion control user interface device 116′ or the anchor point 172 and the second simulated object 132e is the obstacle. In the illustrated embodiments, the simulated motion control user interface device 116′ includes the anchor point 172. However, the process of FIGS. 10-13 does not require the anchor point 172.

As shown in FIG. 12, the second simulated object 132e is positioned along the motion path 236, and the first simulated object 132d has encountered a boundary 136e of the second simulated object 132e while traveling along the motion path 236. Since the second simulated object 132e is a physicalized object, the first simulated object 132d does not pass through the boundary 136d of the second simulated object 132e. In the embodiment of FIG. 12, the analysis of block 212 has determined that the first simulated object 132d will be stopped by the second simulated object 132e. As is shown by the dashed lines, the user slides the first simulated object 132d along the boundary 136e of the second simulated object 132e until the first simulated object 132d has traveled past the boundary 136e of the second simulated object 132e. The user can then command the first simulated object 132e to travel to the simulated motion control user interface device 116′ along a second motion path 238 that is unobstructed.

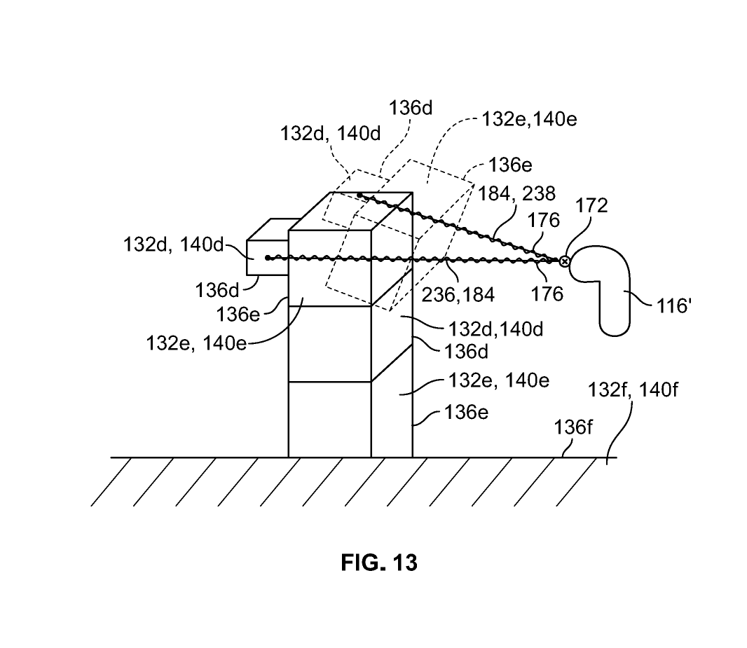

As shown in FIG. 13, the second simulated object 132e is positioned along the motion path 236, and the first simulated object 132d has encountered the boundary 136e of the second simulated object 132e while traveling along the motion path 236. Since the second simulated object 132e is a physicalized object, the first simulated object 132d does not pass through the boundary 136e of the second simulated object 132e. In the embodiment of FIG. 13, the analysis of block 212 has determined that the first simulated object 132d will cause the second simulated object 132e to deflect. As is indicated with the dashed lines, as the first simulated object 132d continues traveling along the motion path 236, the first simulated object 132d causes the second simulated object 132e to deflect laterally and rotationally until the second simulated object is pushed off of the third simulated object 132f and is no longer positioned along the motion path 236. The first simulated object 132d continues traveling along the motion path 236 until the first simulated object 132d reaches the simulated motion control user interface device 116′.

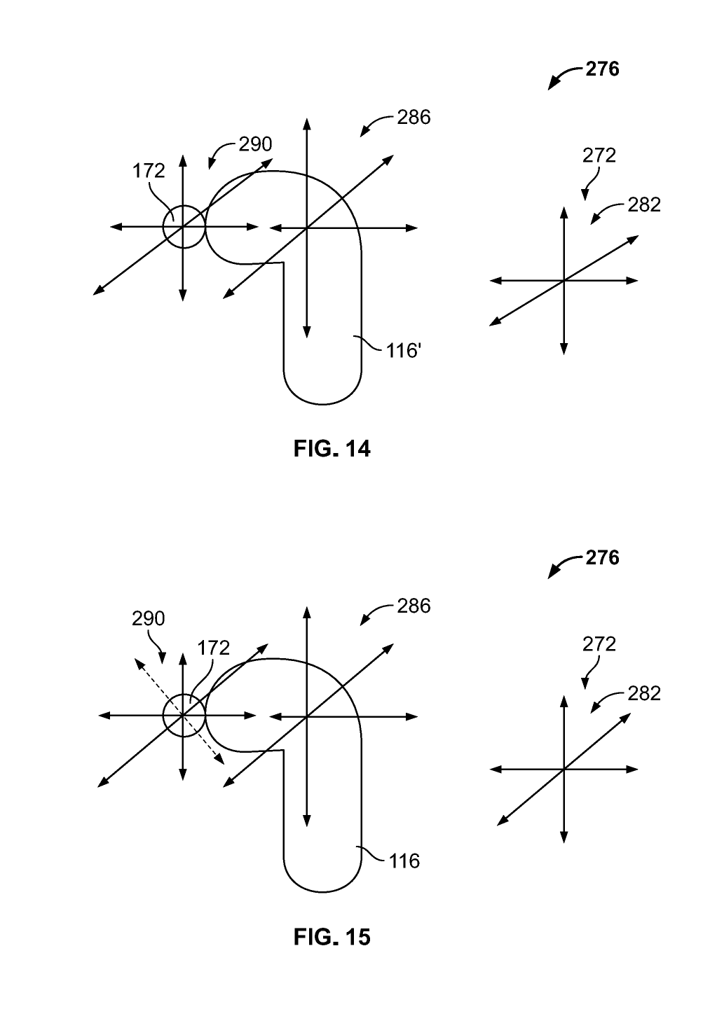

FIGS. 14-18 illustrate the anchor point 172 and a method of using the anchor point 172 to rotate an attached simulated object 132a-132n with respect to the simulated motion control user interface device 116′. As shown in FIG. 14-15, the simulated motion control user interface device 116′ is illustrated independently with respect to a virtual world space 272 of a three-dimensional virtual space 276. The virtual world space 272 is defined by X-, Y- and Z-coordinate axes 282. The simulated motion control user interface device 116′ defines local X- Y- and Z-coordinate axes 286. The simulated motion control user interface device 116′ may be manipulated with respect to the virtual world space 272. For example, in the illustrated embodiment, the simulated motion control user interface device 116′ moves in response to motion of the physical motion control user interface device 116 that is sensed by the motion-responsive input 160. The anchor point 172 is simulated as a dependent (e.g. child) object of the simulated motion control user interface device 116′. The anchor point 172 defines local X-, Y- and Z-coordinate axes 290. The anchor point 172 may be manipulated with respect to the simulated motion control user interface device 116′. For example, the anchor point 172 may be rotated with respect to the simulated motion control user interface device 116′ in response to user actuation of the manipulation input 168 of the physical motion control user interface device 116. Additionally, since the anchor point 172 is simulated as a dependent object of the simulated motion control user interface device 116′, the anchor point 172 moves with the simulated motion control user interface device 116′ as the simulated motion control user interface device 116′ is manipulated with respect to the virtual world space 272. The dashed lines in FIG. 15 shows the local X-, Y-, and Z-coordinate axes 290 of the anchor point 172 after the anchor point 172 has been manipulated relative to the simulated motion control user interface device 116′.

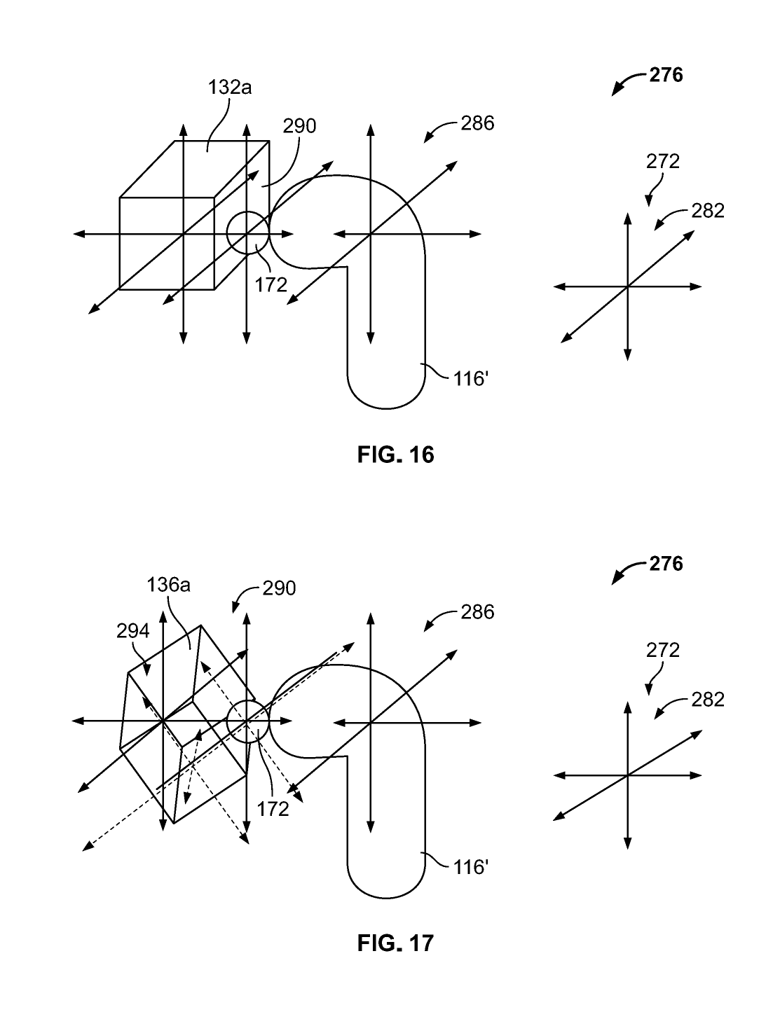

As is shown in FIGS. 16-17, the simulated object 132a-132n may be attached to the anchor point 172 in some embodiments. The simulated object 132a-132n may be directly attached to the anchor point 172 as is shown in FIGS. 16-17. In other embodiments, the simulated object 132a-132n may be attached to the anchor point 172 using the articulation 176 described above. The simulated object 132a-132n defines local X-, Y- and Z-coordinate axes 294.

In some embodiments, the motion of the anchor point 172 with respect to the simulated motion control user interface device 116′ is directly correlated with physical actuation of the manipulation input 168 by the user. In other embodiments, the motion of the anchor point 172 with respect to the simulated motion control user interface device 116′ is indirectly correlated with physical actuation of the manipulation input 168 by the user. For example, in embodiment in which the manipulation input 168 is the joystick, the simulated object 132a-132n engaged with the simulated motion control user interface device 116′ may continue rotating when the joystick has been pushed to a physical rotational boundary of the joystick. In some embodiments, the motion commanded using the second motion control method 302 accelerates in response to a rate of actuation of the manipulation input 168 of the physical motion control user interface device 116. For example, fast actuation of the joystick or fast swipes of the touchpad may result in acceleration of the simulated object 132a-132n and slow actuation of the joystick or slow swipes of the touchpad by result in deceleration of the simulated object 132a-132n.

FIG. 17 shows the local X-, Y-, and Z-coordinate axes 294 of the simulated object 132a-132n and the anchor point 172 after the anchor point 172 has been manipulated relative to the simulated motion control user interface device 116′.

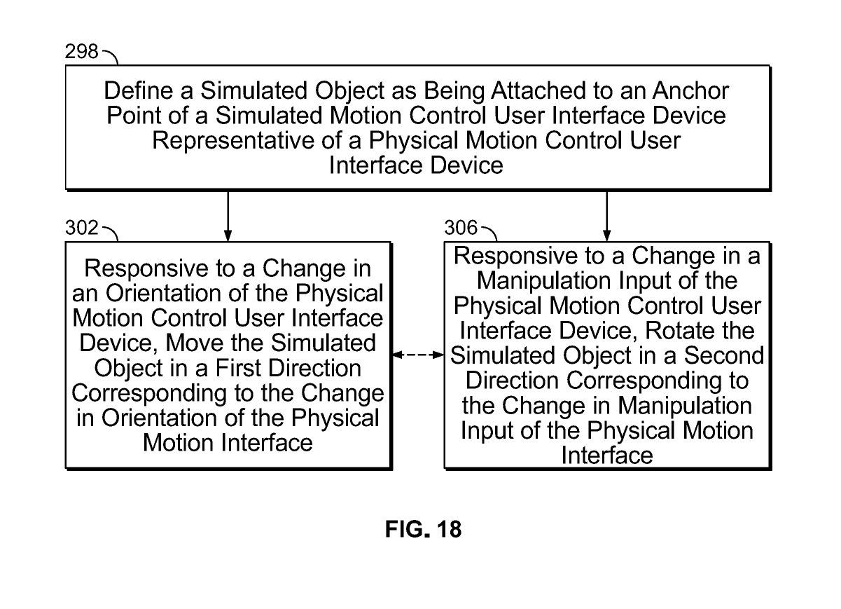

FIG. 18 illustrates the process for using the anchor point 172 to rotate the simulated object 132a-132n with respect to the simulated motion control user interface device 116′ according to some embodiments. The simulated object 132a-132n is defined as being attached to the anchor point 172 (block 298). In some embodiments, the simulated object 132a-132n is directly attached to the anchor point 172. In other embodiments, the simulated object 132a-132n is attached to the anchor point 172 using the articulation 176. The simulated object 132a-132n is then rotated with respect to the virtual world space 272 in response to the motion command signal sent in response to a change in orientation of the physical motion control user interface device 116 sensed using the manipulation input 168 (block 302). The simulated object 132a-132n is then rotated with respect to the simulated motion control user interface device 116′ in response to physical movement of the motion control user interface device 116 sensed by the manipulation input 168 (block 306). In some embodiments, block 302 and block 306 may occur simultaneously, block 302 may occur before block 306, or block 306 may occur before block 302.

The simulated object 132a-132n may be moved in the virtual world space 272 according to the motion control method described in block 302 and the motion control method described in block 306. In the motion control method described in block 302, since the anchor point 172 is dependent on the simulated motion control user interface device 116′, the simulated object 132a-132n may be moved with respect to the virtual world space 272 in response to a change in the physical orientation the physical motion control user interface device 116 that is sensed by the motion-responsive input 160. In the motion control method described in block 306, since the simulated object 132a-132n is attached to the anchor point 172, the simulated object 132a-132n may be moved with respect to the virtual world space 272 in response to by user actuation of the manipulation input 168 and without a change in the physical orientation of the physical motion control user interface device 116. In some embodiments, the change in orientation of the simulated object 132a-132n using the motion control method described in block 302 may be motion about a first axis 311 and the change in orientation of the simulated object 132a-132n using the motion control method described in block 306 may be motion about a second axis 314. In some embodiments, the first axis 311 is different than the second axis 314. In other embodiments, the first axis 311 and the second axis 314 are the same axis. When the motion control method described in block 302 and the motion control method described in block 306 are used simultaneously, the change in orientation of the simulated object 132a-132n is the additive sum of the change of orientation commanded using the motion control method described in block 302 and the change in orientation commanded using the motion control method described in block 306.

The process shown and described in FIGS. 14-18 allows a user to select change the orientation of the simulated objects 132a-132n in the three-dimensional virtual space 276 without changing the physical orientation of the physical motion control user interface device 116. Accordingly, the process shown and described in FIGS. 14-18 to move the simulated objects 132a-132n in ways that would be difficult or impossible for a user to command using the physical motion control user interface device 116. For example, rotation of the simulated objects 132a-132n in the three-dimensional virtual space 224 commanded using the motion-responsive input 160 is limited by how much the user can physically command the hand grasping the physical motion control user interface device 116. If the user desires to command rotation further than is possible or convenient to command using the motion-responsive input 160, the user can command rotation of the simulated objects 132a-132n using the manipulation input 168.

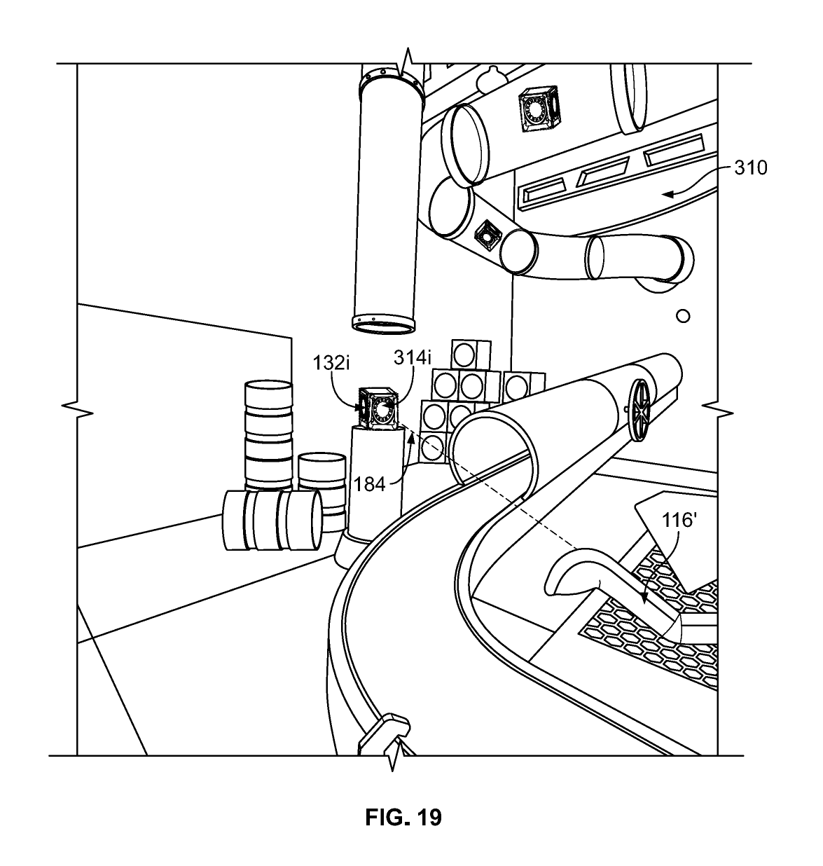

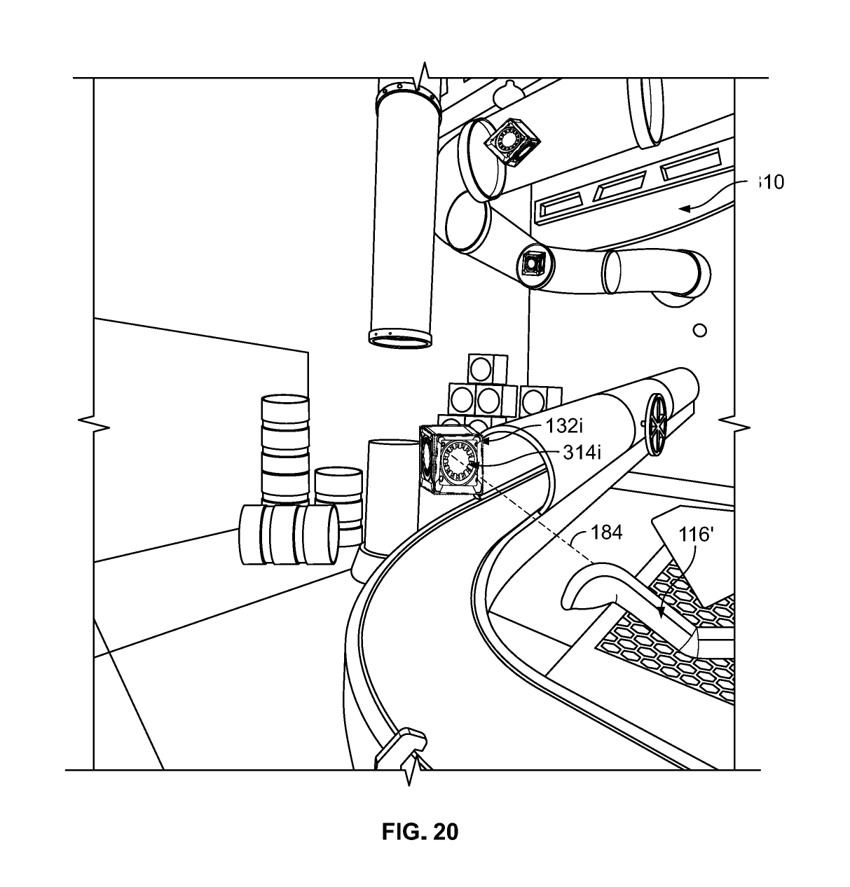

FIGS. 19-22 illustrate an exemplary process that uses the processes described in FIGS. 4, 10, and 18. FIGS. 19-22 illustrate a three-dimensional virtual space 310 in which a first simulated object 132i is spaced from the simulated motion control user interface device 116′. In the illustrated embodiment, the first simulated object 132i is one of the physicalized objects 140a-140n. The first simulated object 132i includes first engagement features 314i. In some embodiments, the first engagement features 314i may be simulated as a part of the first simulated object 132i. In other embodiments, the first engagement features 314i may be simulated as dependent child objects of the first simulated object 132i. As is shown in FIGS. 19 and 20, the first simulated object 132i is selected and pulled towards the simulated motion control user interface device 116′ as described above in FIG. 4 so that the first simulated object 132i is held by the motion control user interface device 116′. In the illustrated construction, the command inputs used in process of FIG. 4 are changes in the physical orientation of the physical motion control user interface device 116.

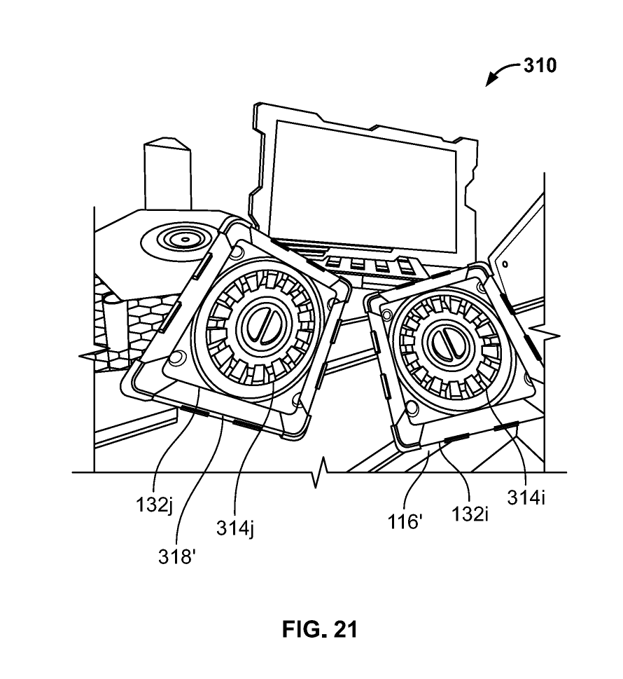

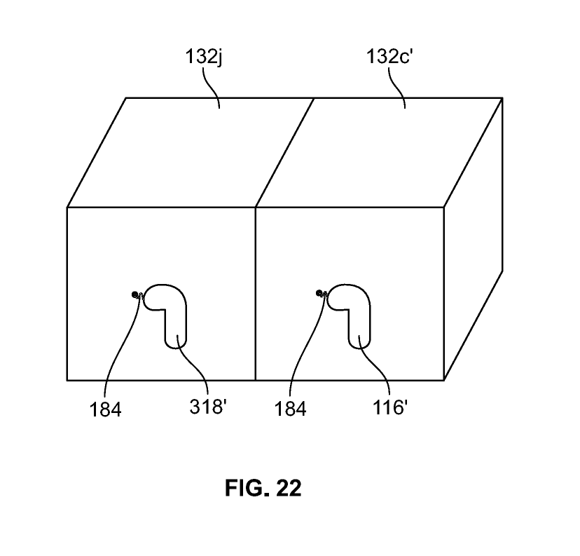

After the first simulated object 132i is held by the simulated motion control user interface device 116′, the computing device 108 may generate at least a second simulated object 132j (FIGS. 21-22) in the three-dimensional virtual space 310. The second simulated object 132j includes second engagement features 314j. The second engagement features 314j are configured to cooperatively receive the first engagement features 314i. The second simulated object 132j is selected and pulled towards a second simulated motion control user interface device 318′ as described for the first simulated object 132i so that the second simulated object 132j is held by the second simulated motion control user interface device 318′. The second simulated motion control user interface device 318′ is generally similar to the motion control user interface device 116′ and will not be described in detail herein for the sake of brevity.

FIG. 21 shows the first simulated object 132i held by the simulated motion control user interface device 116′ and the second simulated object 132j held by the motion control user interface device 116. The user may use the process described in FIG. 18 to manipulate the first simulated object 132i and the second simulated object 132j to align the first engagement features 314i and the second engagement features 314j so that the first simulated object 132i may abut the second simulated object 132j as shown in FIG. 22. As described in FIG. 18, rotation of the first simulated object 132i and the second simulated object 132j may be commanded by changing the physical orientation of the physical motion control user interface device 116 and/or the second physical motion control user interface device 318 and/or actuation of the manipulation input 168 of the first physical motion control user interface device 116 and/or the second physical motion control user interface device 318.

As the first simulated object 132i and the second simulated object 132j are manipulated, the process described in FIG. 10 is used to simulate the behavior of the first simulated object 132i and the second simulated object 132j when the boundaries 136i of the first simulated object 132i and the boundaries 136j of the second simulated object 132j interact.

Various features and advantages of the disclosure are set forth in the following claims.

What is claimed is:

1. A computer-implemented method comprising:
defining a simulated object as being attached to an anchor point of a simulated motion control user interface device representative of a physical motion control user interface device;
moving the simulated object in a first direction in which movement the simulated object with the simulated motion control user interface device in response to a change in an orientation of the physical motion control user interface device; and
moving the simulated object in a second direction in response to a command input using a command interface of the physical motion control user interface device.

2. The computer-implemented method of claim 1, wherein the simulated object is moved in the second direction by moving the anchor point with respect to the simulated motion control user interface device.

3. The computer-implemented method of claim 1, wherein motion of the simulated object in the second direction is not dependent on the change in the orientation of the physical motion control user interface device.

4. The computer-implemented method of claim 1, wherein the motion in the second direction is directly correlated with actuation of the command input of the physical motion control user interface device.

5. The computer-implemented method of claim 1, wherein the motion in the second direction is indirectly correlated with actuation of the command input when the command input is a boundary of the command interface of the physical motion control user interface device.

6. The computer-implemented method of claim 1, wherein the motion in the first direction is about an axis and the motion in the second direction is about the axis.

7. The computer-implemented method of claim 1, wherein the motion in the first direction is about a first axis and the motion in the second direction is about a second axis different than the first axis.

8. A system comprising:
a physical motion control user interface device; and
a computing device in electrical communication with the physical motion control user interface device and comprising at least one processor and a memory, the memory comprising program instructions executable by the at least one processor to:
define a simulated object as being attached to an anchor point of a simulated motion control user interface device representative of the physical motion control user interface device;
responsive to a change in an orientation of the physical motion control user interface device, move the simulated object in a first direction; and
responsive to receiving a command input with a command interface of the physical motion control user interface device, moving the simulated object in a second direction.

9. The system of claim 8, wherein the memory comprises program instructions executable by the at least one processor to move in the second direction by moving the anchor point with respect to the simulated motion control user interface device.

10. The system of claim 8, wherein motion of the simulated object in the second direction is not dependent on the change in the orientation of the physical motion control user interface device.

11. The system of claim 8, wherein the motion in the second direction is directly correlated with actuation of the command input of the physical motion control user interface device.

12. The system of claim 8, wherein the motion in the second direction is indirectly correlated with actuation of the command input when the command input is at a boundary of the command interface of the physical motion control user interface device.

13. The system of claim 8, wherein the motion in the first direction is about an axis and the motion in the second direction is about the axis.

14. The system of claim 8, wherein the motion in the first direction is about a first axis and the motion in the second direction is about a second axis different than the first axis.

15. A computer-readable program product comprising program code, which when executed by a processor, causes an apparatus to perform:
defining a simulated object as being attached to an anchor point of a simulated motion control user interface device representative of a physical motion control user interface device;
moving the simulated object in a first direction in which movement the simulated object with the simulated motion control user interface device in response to a change in an orientation of the physical motion control user interface device; and
moving the simulated object in a second direction in response to a command input using a command interface of the physical motion control user interface device.

16. The computer-readable program product comprising program code of claim 15, wherein the simulated object is moved in the second direction by moving the anchor point with respect to the simulated motion control user interface device.

17. The computer-readable program product comprising program code of claim 15, wherein motion of the simulated object in the second direction is not dependent on the change in the orientation of the physical motion control user interface device.

18. The computer-readable program product comprising program code of claim 15, wherein the motion in the second direction is directly correlated with actuation of the command input of the physical motion control user interface device.

19. The computer-readable program product comprising program code of claim 15, wherein the motion in the second direction is indirectly correlated with actuation of the command input when the command input is a boundary of the command interface of the physical motion control user interface device.

20. The computer-readable program product comprising program code of claim 15, wherein the motion in the first direction is about an axis and the motion in the second direction is about the axis.
